(19) United States
(12) Patent Application Publication
(10) Pub. No.: US 2026/0084387 A1
(43) Pub. Date: Mar. 26, 2026

(54) Multilayer Piezoelectret Film Element, Polymeric Porous Sheet, and Method for Manufacturing the Same

(71) Applicant: HUBEI XIANGYUAN HIGH-TECH CO., LTD, Wuhan City (CN)

(72) Inventors: Xin Zhang, Wuhan City (CN); Qiong Wei, Wuhan City (CN)

(21) Appl. No.: 19/328,828

(22) Filed: Sep. 15, 2025

(30) Foreign Application Priority Data
Sep. 20, 2024 (CN) 202411311128.X

(51) Int. Cl. B29D 7/01; B29C 35/08; B29K 23/00; B29K 105/04; B29K 105/24

(52) U.S. Cl. CPC B29D 7/01; B29C 35/0866; B29C 2035/0877; B29K 2023/0625; B29K 2105/041; B29K 2105/24; B29K 2995/0003; B29K 2995/0063; B29K 2995/0097

(57) ABSTRACT

A multilayer piezoelectret film element, a polymeric porous sheet, and a method for preparing them are disclosed. The present disclosure ensures that the gas can be ionized without damaging the polymeric porous sheet by adjusting the gap between pores and the dielectric strength of the polymeric porous sheet in the multilayer piezoelectret film element. The polymeric porous sheet has a high piezoelectric constant after electric polarization and surface metallization treatment, and can generate a significant amount of charge under mechanical pressure, thereby exhibiting high sensitivity in applications such as piezoelectric sensors, and solving the problems of low piezoelectric activity and fast loss of piezoelectric activity of the polarized polymeric piezoelectret film element in the art. Moreover, the production process is simple, which can ensure continuous production of the polymeric piezoelectret film element.

### CROSS-REFERENCE TO RELATED APPLICATIONS

This application claims priority under 35 U.S.C. § 119 or 365 to Chinese Application No. 202411311128.X, filed Sep. 20, 2024, the entire disclosures of which are incorporated herein by reference.

### FIELD OF THE DISCLOSURE

The present disclosure relates to a multilayer piezoelectret film element, a polymeric porous sheet, and a method for manufacturing them, and belongs to the field of polymer piezoelectret sheets.

### BACKGROUND

With the continuous advances in science and technology, there is an increasing demand for high-performance sensors, especially in the field of acoustic detection and identification. Polymeric porous piezoelectret sheets have become a research hotspot due to their high sensitivity and low acoustic impedance. Such materials can convert acoustic energy into electrical signals, and are widely used in various small devices, such as smart phones and tablet computers. In addition, polymeric porous piezoelectret sheets are light and thin and have a simple structure, making it possible to develop novel wearable devices. For example, by combining them with flexible electronics technologies, wearable acousto-electric sensors capable of monitoring human sound signals or environmental sound changes can be designed, offering great potential for applications in fields such as medical health monitoring and environmental sound analysis.

However, there are some challenges in manufacturing polymeric piezoelectret sheets in the art. Conventional production methods face difficulties in carrying out continuous production, resulting in low production efficiency and inability to meet the needs of large-scale applications. Furthermore, the manufactured piezoelectric sheets often have low piezoelectric activity, and rapidly lose the piezoelectric activity after polarization, which limits their application and development in the field of high-performance sensors.

The prior-art document CN117395581A discloses a porous polymeric piezoelectret sheet including, but not limited to, a polypropylene (PP) sheet. The interior of the porous polymeric piezoelectret sheet may include honeycomb-like lenticular pores. Furthermore, the thickness of the porous polymeric piezoelectret sheet may be between 30 μm and 80 μm. The electroacoustic device manufactured by utilizing the inverse piezoelectric effect of the porous polymeric piezoelectret sheet has advantages in reducing the volume, reducing the number of parts, and improving reliability, and can achieve a higher piezoelectric coefficient and sensitivity. However, the above-mentioned problems of low piezoelectric activity and rapid loss of piezoelectric activity after polarization are still present in actual production and application.

Likewise, the prior-art document CN116419654A describes applications of a PP piezoelectret sheet in electroacoustic conversion, but does not completely solve the problems associated with continuous production, piezoelectric activity, and stability in the art.

In summary, despite certain progress made in the art in the application of polymeric porous piezoelectret film elements, there are still many problems and challenges in material preparation, production efficiency, piezoelectric activity, and stability. These problems limit further development and wide application of polymeric porous piezoelectret sheets in the field of acousto-electric sensors. Therefore, it is necessary to make in-depth analysis and improvements over the prior art to overcome these challenges and promote the technical progress and industrial development in this field.

### SUMMARY

In order to address the drawbacks in the art, an objective of the present disclosure is to provide a multilayer piezoelectret film element, a polymeric porous sheet, and a method for manufacturing them. It aims to solve the problems that the polymeric piezoelectret film elements in the art have low piezoelectric activity and rapidly lose the piezoelectric activity after polarization. The method has a simple production process, and can ensure continuous production of polymeric piezoelectret film elements.

The inventors have conducted extensive research and discovered that if the gap between pores and the dielectric strength of a polymeric porous sheet used for a piezoelectret are properly adjusted, it can be ensured that the gas can be ionized without damaging the polymeric porous sheet, thereby completing the present invention. It should be noted that the gap between pores herein is reflected by the number ratio of pores having a pore diameter within a specific range in the thickness direction, and by the thickness ratio of the polymer matrix excluding pores.

The essential aspects of the present disclosure are the following (1)-(3):
(1) A multilayer piezoelectret film element, comprising a first conductive layer 2, a flexible porous film layer 3, and a second conductive layer 4 in sequence, wherein the flexible porous film layer 3 comprises a polymeric porous sheet, and the polymeric porous sheet has a thickness H of 50-2,000 μm and a density of 100-900 kg/m³;
the pores having a D_{zd} in the range of 5 μm to 50 μm account for 80% or more of the total number of pores in the polymeric porous sheet, where D_{zd} is defined as the maximum pore diameter of a single pore in the thickness direction;
Hₚ/H is 5%-60%, where Hₚ is defined as the average value of the cumulative thicknesses of the polymer matrix excluding pores in the thickness direction, and H is defined as the thickness of the polymeric porous sheet; and
the dielectric strength of the polymeric porous sheet in the thickness direction is 10-60 MV/m.
(2) A polymeric porous sheet, wherein the polymeric porous sheet has a thickness H of 50-2,000 μm and a density of 100-900 kg/m³;
the pores having a D_{zd} in the range of 5 μm to 50 μm account for 80% or more of the total number of pores in the polymeric porous sheet, where D_{zd} is defined as the maximum pore diameter of a single pore in the thickness direction;
Hₚ/H is 5%-60%, where Hₚ is defined as the average value of the cumulative thicknesses of the polymer matrix excluding pores in the thickness direction, and H is defined as the thickness of the polymeric porous sheet; and
the dielectric strength of the polymeric porous sheet in the thickness direction is 10-60 MV/m.
(3) A method for manufacturing a polymeric porous sheet by subjecting at least a base resin to extrusion molding, electron beam radiation crosslinking, foaming at atmospheric pressure and a high temperature, bidirectional stretching, and calendering; wherein the base resin is a blended resin obtained by melt blending of a composition comprising two or more polyolefin resins but not subjected to crosslinking and foaming, and the base resin has a dielectric constant of 2.2-2.4 and a melting peak temperature of 135-150° C.; optionally, the base resin has a standard crosslinking degree of 40-80% at a radiation dose of 25 Mrad.

### Beneficial Effects of the Invention

The multilayer piezoelectret film element according to the present disclosure comprises a polymeric porous sheet. The polymeric porous sheet has a high piezoelectric constant after electric polarization and surface metallization treatment, and can generate a significant amount of charge when exposed to mechanical pressure, so that the multilayer piezoelectret film element according to the present disclosure exhibits high sensitivity in applications such as piezoelectric sensors, shows high piezoelectric activity, and suffers less loss of piezoelectric activity after polarization.

Moreover, the multilayer piezoelectret film element according to the present disclosure has good mechanical strength without loss of flexibility and recoverability. As its essential component, the polymeric porous sheet maintains good shape stability when compressed or stretched, is lightweight, and can be better combined with flexible electronics technologies, allowing development of wearable acousto-electric sensors.

Furthermore, the polymeric porous sheet, as the essential component of the multilayer piezoelectret film element according to the present disclosure, can be used in a high-temperature environment at 60° C. while maintaining good shape stability, with its dimensional change controlled within a range from −5% to 5%.

Additionally, the production process according to the present disclosure is simple and enables continuous production of materials. As compared with conventional piezoelectric ceramic sensors and PVDF-based piezoelectric sensors, the multilayer piezoelectret film element according to the present disclosure has the advantages such as a low price, a light weight, a simple structure, and the like, rendering it with a significant cost benefit in market competition.

### BRIEF DESCRIPTION OF DRAWINGS

FIG. 1 is a schematic representation of the structure of a multilayer piezoelectret film element according to an embodiment of the present disclosure;

FIG. 2 is a schematic representation of a theoretical alternating configuration of the polymer matrix and pores in the polymeric porous sheet;

FIG. 3 is an SEM image of a cross-section of the polymeric porous sheet of Example 1.

In the figures, 1: base support layer; 2: first conductive layer; 3: flexible porous film layer; 4: second conductive layer; 5: overcoat layer.

### DETAILED DESCRIPTION OF EMBODIMENTS

The present disclosure will be described in detail hereinafter by way of examples. It is noteworthy that the following examples are only used to further illustrate the present disclosure and should not be interpreted as limiting the scope of protection of the present disclosure, and a person skilled in the art can make non-essential improvements and adjustments to the present disclosure according to the above contents.

### Multilayer Piezoelectret Film Element

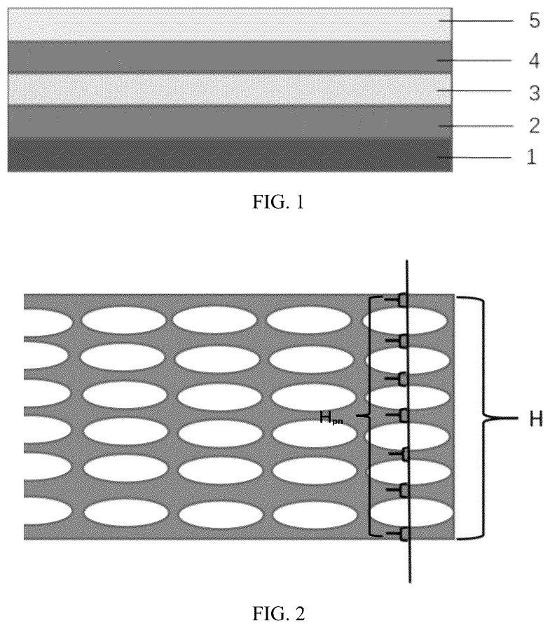

The multilayer piezoelectret film element according to the present disclosure, as shown in FIG. 1, sequentially comprises a first conductive layer 2, a flexible porous film layer 3, and a second conductive layer 4. The other side of the first conductive layer 2 may be further provided with a base support layer 1, and the other side of the second conductive layer 4 may be further provided with an overcoat layer 5. A person skilled in the art would understand that one side of the first conductive layer 2 is provided with the flexible porous film layer 3, and the other side of the first conductive layer 2 may be further provided with the base support layer 1; one side of the second conductive layer 4 is provided with the flexible porous film layer 3, and the other side of the second conductive layer 4 may be further provided with the overcoat layer 5. Depend on different application scenarios, the base support layer 1 and the overcoat layer 5 may be unnecessary, and the multilayer piezoelectret film element may sequentially include only the first conductive layer 2, the flexible porous film layer 3, and the second conductive layer 4 in some application scenarios.

The flexible porous film layer 3 is the essential component of the present disclosure, and includes a polymeric porous sheet having a piezoelectric effect. By the piezoelectric effect, it can directly convert the mechanical energy into an electrical signal. The flexible porous film layer is laid on the base support layer 1 in the form of a thin film in the multilayer piezoelectret film element. In order to achieve omnidirectional perception in a three-dimensional space, the flexible porous film layer 3 may be designed in an array form, or even distributed in a complex pattern such as a grid shape or a spiral shape, so as to improve tactile resolution and positioning accuracy.

The base support layer 1 is made of a soft and elastic polymer material, such as silicone rubber, polyurethane, or the like, which provides physical support and ductility and ensures that it can adapt to various complex surface deformations.

The first conductive layer 2 and the second conductive layer 4 are used to collect and transmit electrical signals generated by the flexible porous film layer 3. The material for these two layers may be metal nanowire network, carbon nanotube, graphene, a conductive polymer, or the like. These materials have good conductivity and flexibility and can be tightly combined with the flexible porous film layer 3 to ensure effective transmission of electrical signals.

The overcoat layer 5 is used to protect the internal structure from the environment, and is usually made of a wear-resistant, moisture-proof, and corrosion-resistant material, such as a Teflon coating, flexible glass, and the like, to ensure long-term stability and reliability of the multilayer piezoelectret film element.

Since the multilayer piezoelectret film element as a whole is characterized by softness and bendability, it is very suitable for applications that require high sensitivity and adaptability to complex surfaces, such as for integration in smart watches and health bracelets, for monitoring physiological parameters such as heart rate, blood pressure, and respiratory rate that provide real-time health data for the user; or for use in the skin structure of a robot to render the robot with more delicate tactile perception and a more natural interaction ability.

### Polymeric Porous Sheet

The polymeric porous sheet according to the present disclosure is mainly used as a material for the flexible porous film layer 3 in the multilayer piezoelectret film element. It has a porous structure, in which the polymer matrix is separated by pores, forming a structure in which the polymer matrix and the pores are alternatingly arranged in the thickness direction. In other words, the polymeric porous sheet according to the present disclosure comprises a polymer matrix and pores. During polarization, gas molecules in the pores are ionized, creating positive and negative charges. These charges are deposited on the surface of the polymer matrix under the action of an electric field to form a stable charge distribution. Due to the isolation effect of the pores, these charges can still be retained in the material after the external electric field is ceased, thereby imparting the material with long-lasting piezoelectric properties.

Moreover, in addition to the use in a multilayer piezoelectret film element, the polymeric porous sheet according to the present disclosure may also be applied to a protective buffer plate of a vehicle-mounted device or a display, thanks to its thermal resistance and buffering ability as well as its performance in protecting antenna components from clutter interference.

The ordered arrangement of the polymer matrix and the pores in the thickness direction of the polymeric porous sheet enables the material to generate a significant charge response in a localized region under mechanical stress. This localized charge response manifests as a macroscopic piezoelectric effect of the entire material, i.e., the material is capable of producing an electrical signal when subjected to pressurizing or stretching.

### Thickness

The thickness of the polymeric porous sheet according to the present disclosure is desirably 50 μm or more, preferably 80 μm or more, more preferably 100 μm or more, further preferably 150 μm or more, and even further preferably 200 μm or more, from the viewpoint of prevention of electric breakdown damage to the material due to a too thin thickness and also from the viewpoint of improvement in material strength and mechanical durability.

The thickness is 2,000 μm or less, preferably 1,000 μm or less, more preferably 900 μm or less, further preferably 800 μm or less, and still further preferably 700 μm or less, from the viewpoint of compliance, softness, and polarization uniformity.

If an appropriate thickness range is selected in this way, the polymeric porous sheet can not only provide dielectric strength that meets the scope of the present disclosure and maintain a relatively high piezoelectric constant, but also ensure ideal softness, compliance, and mechanical strength durability, while addressing the technical problem of the contradiction between prevention of electric breakdown of the material during polarization and prevention of ununiform polarization.

### Pores

In addition to the polymer matrix, the rest part of the polymeric porous sheet is composed of pores, and the pores contain gas which can be polarized and generate charges in an electric field. The commonly used gas includes one or more selected from air, nitrogen, oxygen, argon, carbon dioxide, fluorine gas, chlorine gas, and water vapor. In comprehensive consideration of the cost, the polarization effect, and maintenance of chemical inertness during polarization, air or nitrogen is preferred.

Due to the presence of pores, the density of the polymeric porous sheet according to the present disclosure is lower than that of the polymer matrix. The density is 100 kg/m³ or more, preferably 150 kg/m³ or more, more preferably 200 kg/m³ or more, and further preferably 250 kg/m³ or more, from the viewpoint of improving mechanical durability and dielectric strength; and the density is 900 kg/m³ or less, preferably 850 kg/m³ or less, more preferably 800 kg/m³ or less, and further preferably 600 kg/m³ or less, from the viewpoint of improving softness and piezoelectric activity of the polymeric porous sheet. The density of the polymeric porous sheet was determined according to GB/T 40872-2021. From the viewpoint of piezoelectric conversion, if the density of the polymeric porous sheet is lower than 100 kg/m³, the dielectric strength of the material decreases, and electric breakdown may occur during polarization, which may damage the piezoelectric performance of the material and may result in a permanent loss of piezoelectric activity; and if the density of the polymeric porous sheet is greater than 900 kg/m³, the gas available for ionization in the pores is insufficient, the polarization activity is reduced, and the polymer material may also be too dense, which limits the mobility of the polymer chains, thereby reducing the charge generated under mechanical stress and resulting in reduced piezoelectric activity.

The configuration and positions of pores in the polymeric porous sheet has a great influence on the piezoelectric performance. Generally the piezoelectret sheet (i.e., the flexible porous film layer 3) formed by the polymeric porous sheet according to the present disclosure is sandwiched between a flexible lower electrode (i.e., the first conductive layer 2) and a flexible upper electrode (i.e., the second conductive layer 4), and the piezoelectric effect is usually generated in the thickness direction of the polymeric porous sheet. Therefore, the present disclosure focuses on the distribution of pores in the thickness direction of the polymeric porous sheet.

D_{zd} is defined as the maximum pore diameter of a single pore in the thickness direction. Specifically, D_{zd} is obtained by selecting two points on the surface of a single pore such that the line connecting these two points is parallel to the thickness direction of the material, and the distance between these two points is the maximum value between all possible point pairs. In other words, D_{zd} is the longest linear distance measured along the thickness direction between the two sides of the pore in the thickness direction of the material. The value of D_{zd} can be effectively measured by measurement techniques such as microscopic measurement and three-dimensional scanning. Adjustment of D_{zd} is of great significance for maintaining high dielectric strength and a high piezoelectric constant of the polymeric porous sheet in the thickness direction. For the polymeric porous sheet, the average value of D_{zd} is 10-80 μm, preferably 15-75 μm, further preferably 20-60 μm.

The inventors have found that both dielectric strength and a high piezoelectric constant that meet the scope of the present disclosure can be obtained when the number of pores having a D_{zd} in the range of 5 μm to 50 μm account for 80% or more, preferably 85% or more, more preferably 90% or more, and even more preferably 95% or more, of the total number of pores in the polymeric porous sheet. When the number of pores having a D_{zd} in the range of 5 μm to 50 μm account for less than 80% of the total number of pores in the polymeric porous sheet, there may be the following disadvantages in terms of pore distribution:
(1) The average pore diameter is too large, that is, most pores have a D_{zd} greater than 50 μm, so that the number of pores having a D_{zd} in the range of 5 μm to 50 μm does not account for 80% or more of the total number of pores in the polymeric porous sheet. In this case, the polymer matrix in the thickness direction is too little, the portion of pores is too large, and the dielectric strength is too low, making electrical breakdown more likely to occur under the same electric field intensity.
(2) The average pore diameter is too small, that is, most pores have a D_{zd} less than 5 μm, so that the number of pores having a D_{zd} in the range of 5 μm to 50 μm does not account for 80% or more of the total number of pores in the polymeric porous sheet. In this case, the pores in the polymeric porous sheet are small, the continuity of the polymer matrix is increased, and the deformation of the polymer chains and the reorientation of the polar groups become crucial to the generation of charges. If the pores are too dense, movement of the polymer chains may be limited, thereby reducing the amount of charge generated under mechanical stress, resulting in a decrease in the piezoelectric constant of the material.
(3) The pore diameter exhibits a bimodal distribution, but the ratio of pores having a D_{zd} falling within the range of 5 μm to 50 μm is not high. Since the pore diameter is not uniform, the material may exhibit uneven polarization, which in turn affects the stability and reliability of the dielectric strength and piezoelectric constant of the entire material.

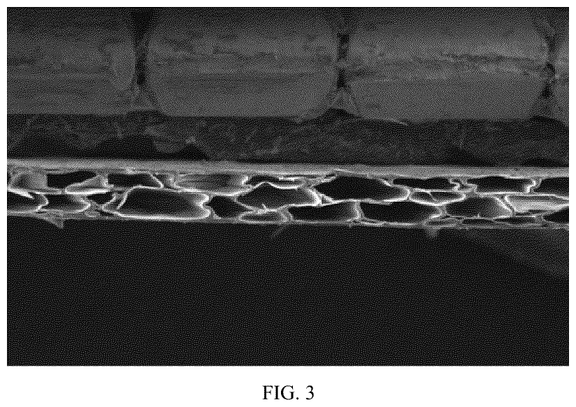

In addition, the polymeric porous sheet forms an alternating pattern of the polymer matrix and the pores in the thickness direction, as shown in FIG. 2. Hₚ is defined as the average value of the cumulative thicknesses of the polymer matrix excluding pores in the thickness direction. As shown in FIG. 2, the polymer matrix is divided into multiple layers by the pores in the thickness direction. As regards the cumulative thickness of the polymer matrix in the polymeric porous sheet in the thickness direction, Hₚₙ is defined as the cumulative thickness of the polymer matrix at a certain point on the polymeric porous sheet in parallel to the thickness direction from the upper surface to the lower surface, and Hₚ is defined as the average value of all Hₚₙs on the entire polymeric porous sheet, which can be expressed by the following equation:

$${H}_{p} = \frac{1}{N} {\sum }_{n = 1}^{N} {H}_{pn} ;$$

wherein, N is the number of random points taken on the whole polymeric porous sheet, usually on a polymeric porous sheet sample with a plane size of 5 cm×5 cm, and N is not less than 50; the larger N is, the closer it is to the true Hₚ average value of the whole polymeric porous sheet.

In the present disclosure, Hₚ/H is 5%-60%, where H is the thickness of the polymeric porous sheet, which is described in the section <Thickness>. Here, it is further specified that it refers to the sum of the thicknesses of the polymer matrix and the pores in the thickness direction. Preferably, Hₚ/H is 10%-50%, more preferably 15%-45%, and even more preferably 20%-40%. Within the above range, the distribution of the polymer matrix and the pores in the thickness direction of the polymeric porous sheet is appropriate, and can satisfy the mechanical strength, the dielectric strength, and the polarization efficiency at the same time, thereby improving the stability and reliability of the polymeric porous sheet in use.

In the present disclosure, the open porosity of the polymeric porous sheet is 20% or less, preferably 15% or less, further preferably 10% or less, and even more preferably 7% or less. If the open porosity of the polymeric porous sheet is too high, e.g. greater than 20%, more open pores are formed, causing electric field leakage, reduced electric field intensity inside the material, and reduced dielectric strength, and meanwhile possible leakage of charges through the open pores may reduce the polarization efficiency and piezoelectric activity of the material. Furthermore, if the closed porosity of the polymeric porous sheet is increased, the deformation of the pores under an impact can be suppressed, and thus the deformation of the polymeric porous sheet under the impact can also be suppressed, thereby easily improving the impact absorption.

### Dielectric Strength

The polymeric porous sheet according to the present disclosure has a dielectric strength of 10-60 MV/m in the thickness direction, which is a high dielectric strength.

### Raw Material Mixture

The polymeric porous sheet of the present disclosure is made from a raw material mixture comprising a base resin. The base resin and additives in the raw material mixture will be described hereinafter.

### Base Resin

The base resin for the polymeric porous sheet according to the present disclosure comprises a polyolefin resin. The polyolefin resin includes at least a polypropylene (PP)-based resin. From the viewpoint of dielectric strength, piezoelectric constant, and foaming performance, the polyolefin resin is preferably a PP-based resin, or a mixture of a PP-based resin and other resin(s).

Examples of the PP-based resin include a propylene homopolymer, a propylene-ethylene copolymer, a propylene-ethylene-α-olefin copolymer, a propylene-α-olefin copolymer, and the like. They can be used alone or as a combination of two or more. The α-olefin constituting the propylene-α-olefin copolymer may be specifically 1-butene, 1-pentene, 4-methyl-1-pentene, 1-hexene, 1-heptene, 1-octene, or the like. Among them, α-olefins having 6-12 carbon atoms are preferred. For the propylene copolymers, the content of the structural unit derived from propylene in the copolymer is 50 wt % or more, and it may be 60 wt % or more, 70 wt % or more, 80 wt % or more, 90 wt % or more, 95 wt % or more, or 99 wt % or more.

As for the mixture of a PP-based resin and other resin(s), examples of the other resin(s) include a polyethylene (PE)-based resin, vinyl chloride resin (polyvinyl chloride, PVC), polystyrene (PS), polyurethane resin (PU), polycarbonate (PC), polyacetal (POM), polyphenylene ether (PPE), a methacrylic resin (PMMA), acrylonitrile styrene resin (SAN), amorphous polyethylene terephthalate (PETG), polyimide resin (PI), polyolefin plastomer (POP), polyamide-imide resin, polyarylate, polysulfone (PSU), polyethylene naphthalate (PEN), polyethylene terephthalate (PET), polybutylene terephthalate (PBT), acrylonitrile-butadiene-styrene resin (ABS), and a fluorine resin (PTFE, PCTFE, etc.). Preferably, a PP-based resin is blended with a PE-based resin and/or a polyolefin plastomer. In consideration of controlling of the dielectric strength and piezoelectric performance as well as the compatibility of the polymer, when a PP-based resin is blended with other resins, the content of the PP-based resin is 40-80 wt % of the total content of the mixture of the PP-based resin and other resins, and it may further be 45 wt %, 50 wt %, 55 wt %, 60 wt %, 65 wt %, 70 wt % or 75 wt %.

In one embodiment, the base resin for the polymeric porous sheet includes two or more polyolefin resins. Herein the base resin refers to a blended resin obtained by melt blending of a composition comprising two or more polyolefin resins but not subjected to crosslinking and foaming. By selection of the blended polyolefin resins, the base resin has a dielectric constant of 2.2-2.4 and a melting peak temperature of 135-150° C. Furthermore, the base resin has a standard crosslinking degree of 40-80% at a radiation dose of 25 Mrad. It should be noted that the standard crosslinking degree herein refers to the crosslinking degree of the crosslinked resin formed from the base resin at a radiation dose of 25 Mrad. It should also be noted that the above dielectric constant, melting peak temperature, and crosslinking degree refer to the characteristics of the base resin without additives.

When the base resin is selected from the polymers of the above types at the above contents according to the present disclosure, the dielectric constant is generally in the range of 2.2-2.4. The blended resin having a dielectric constant in this range helps maintain stable charge accumulation during polarization, thereby improving the piezoelectric performance of the overall polymeric porous sheet. A base resin with a high melting temperature helps maintain the mechanical strength and chemical stability of the material in high-temperature environments; and the cross-linkable property of the blended resin is passed onto the final polymeric porous sheet, and the cross-linkable property of the final product will be described in detail in the sections below. The selection and control of the melting peak temperature and the standard crosslinking degree at a radiation dose of 25 Mrad of the base resin are important factors controlling the pore diameter and distribution of the pores after foaming and crosslinking. In addition, a person skilled in the art can obtain the above performance and characteristics of the base resin by selecting polyolefin resins of appropriate types and structures.

### Additives

The raw material mixture for preparing the polymeric porous sheet according to the present disclosure may include a foaming agent in addition to the base resin. Optionally, the raw material mixture may further include a foaming aid. Optionally, the raw material mixture may further include a crosslinking aid. Optionally, depending on applications, the raw material mixture may further include other functional additives, such as antioxidants, ultraviolet light absorbers, processing aids, flame retardants, antistatic agents, etc.

### Crosslinking

From the viewpoint of improving the controllability of pores in the polymeric porous sheet and the softness of the polymeric porous sheet, the polymeric porous sheet according to the present disclosure is a crosslinked foamed sheet with a crosslinking degree of 10-70%, preferably 15% or more, further preferably 20% or more, and preferably 65% or less, further preferably 60% or less. When the crosslinking degree is lower than 10%, the polymeric porous sheet lacks sufficient mechanical strength and structural stability, which causes the material to be easily deformed or broken under external force, and affects the actual durability; and when the crosslinking degree is higher than 70%, the material becomes too rigid and fragile, which is unfavorable to its application in flexible electronics, and meanwhile the excessively high crosslinking degree may limit the movement of the polymer chains, which may also cause reduced dielectric strength and piezoelectric performance of the material.

In one embodiment, by controlling the type of the polyolefin resin in the base resin and the crosslinking degree of the base resin, the polymeric porous sheet may comprise a xylene-soluble portion and a xylene-insoluble portion; wherein in the DSC curve of the soluble portion, the ratio of the peak area of a melting temperature above 130° C. to the total peak area is 10%-40%. The ratio of the peak area of a melting temperature above 130° C. in the DSC curve of the soluble portion reflects the content of the soluble polypropylene fraction.

Within this range, the polymer regularity and crystallinity of the overall polymeric porous sheet may be promoted, so that the stability of the space charge is improved. The insoluble portion is a crosslinked amorphous region, which provides mechanical strength and chemical stability for the material. However, an excessively high crosslinking degree limits the mobility of the molecular chains, which is unfavorable to the free distribution and storage of charge inside the molecular chains. The peak area of the melting temperature below 130° C. in the DSC curve of the soluble portion reflects the polyethylene portion, which can also provide good charge storage capacity, processability, and flexibility, but its charge storage stability is poor. Therefore, in order to improve the charge storage capacity, storage stability, processability, and flexibility of the material at the same time, not only the crosslinking degree of the material but also the PP content of the non-crosslinked part (i.e., the ratio of the peak area of the melting temperature above 130° C. in the DSC curve of the soluble portion) need to be controlled. Preferably, the ratio of the peak area of the melting temperature above 130° C. in the DSC curve of the soluble portion is 15%-35%, preferably 20%-30%.

### Dimensional Stability

The polymeric porous sheet according to the present disclosure exhibits excellent dimensional stability in high-temperature environments. Under the test condition at 60° C., the dimensional change rate of the polymeric porous sheet remains in the range of −5% to 5%, preferably in the range of −3% to 3%, to ensure reliability and performance consistency of the material under various environmental conditions. If the dimensional change rate is outside of this range, for example, greater than 5%, it may cause deformation or performance degradation of the material in high-temperature applications, thereby affecting its applicability and durability in sophisticated flexible electrets.

### Elongation at Break

The polymeric porous sheet according to the present disclosure has an elongation at break greater than 100%, thereby promoting good softness and recoverability of the material.

### Compressive Stress

The polymeric porous sheet according to the present disclosure exhibits a stress of 5 kPa to 150 kPa, preferably 10 kPa to 100 kPa, at a compression of 10%, to ensure mechanical stability and reliability of the material under mild to moderate pressure. If the compressive stress is lower than the lower limit of the numerical range, for example, less than 5 kPa, the material may not withstand the expected load in practical applications, which affects its performance as a structural material; and if the compressive stress is higher than 150 kPa, the material may be too fragile, increasing the risk of fatigue damage in long-term use.

### Manufacturing Process

The method for manufacturing the polymeric porous sheet according to the present disclosure comprises the following step: manufacturing the polymeric porous sheet by subjecting at least a base resin (specifically a raw material mixture comprising the base resin) to extrusion molding, electron beam radiation crosslinking, foaming at atmospheric pressure and a high temperature, bidirectional stretching, and calendaring.

The base resin for the polymeric porous sheet includes two or more blended polyolefin resins. Preferably, the dielectric strength of at least one of the polyolefin resins is greater than 18 MV/m at room temperature, and the melting peak temperature of at least one of the polyolefin resins is 120° C. or higher; and at least one of the polyolefin resins may be cross-linked under electron beam irradiation, and have a crosslinking degree of 10-80% at a radiation dose of 25 Mrad.

The steps are described in detail as follows:

### Extrusion Molding

In the step of extrusion molding, the base resin (or the raw material mixture comprising the base resin) is passed through an extruder head to form a continuous sheet having a specific thickness. During this process, the extrusion temperature is maintained between 130° C. and 140° C. to ensure adequate plasticization of the resin and uniformity of the sheet. The extrusion speed was controlled at 2-20 m/min to ensure continuity and consistency of the sheet.

### Electron Beam Radiation Crosslinking

In the present disclosure, after the base resin (or the raw material mixture including the base resin) is mixed and molded by extrusion, it is subjected to a gelation reaction, that is, a crosslinking reaction. The crosslinking may be performed by well-known techniques in the art. Common techniques include for example radiation crosslinking or chemical crosslinking, preferably radiation crosslinking.

Radiation crosslinking is performed by irradiating the resin sheet with ionizing radiation such as electron rays, a rays, B rays, and y rays. The irradiation dose of the ionizing radiation is adjusted in such a way that the crosslinking degree of the obtained foamed sheet is within a desired range, and for example, may be 10 Mrad-30 Mrad, preferably 12 Mrad-28 Mrad, and further preferably 15 Mrad-25 Mrad. The energy for radiation crosslinking influences the rate of crosslinking, and is generally selected to be 1.0 Mev-3.0 Mev, preferably 1.2 Mev-2.8 Mev, and further preferably 1.5 Mev-2.5 Mev.

Crosslinking aids may also be added to reduce the dose of ionizing radiation in the irradiation crosslinking process, and to prevent cleavage and deterioration of resin molecules accompanied by ionizing irradiation.

Examples of the crosslinking aids include: compounds having three functional groups in the molecule, such as trimethylolpropane trimethacrylate, trimethylolpropane triacrylate, triallyl trimellitate, triallyl 1,2,4-benzenetricarboxylate, and triallyl isocyanurate; compounds having two functional groups in the molecule, such as 1,6-hexanediol dimethacrylate, 1,9-nonanediol dimethacrylate, 1,10-decanediol dimethacrylate, and divinylbenzene; diallyl phthalate, diallyl terephthalate, diallyl isophthalate, ethylvinylbenzene, neopentyl glycol dimethacrylate, lauryl methacrylate, stearyl methacrylate, and the like. These crosslinking aids are used alone or as a combination of two or more. The crosslinking aids are added in an amount of preferably 0.1-1 parts by mass relative to 100 parts by mass of the base resin.

### Foaming at Atmospheric Pressure and a High Temperature

The foaming is conducted by heating the crosslinked resin sheet to decompose a thermal-decomposition foaming agent. As the thermal-decomposition foaming agent, for example, a foaming agent having a decomposition temperature higher than the melting temperature of the polyolefin resin is used. Specifically, an organic or inorganic chemical foaming agent having a decomposition temperature of 160-270° C. may be used.

Examples of the organic foaming agent include: azo compounds such as azodicarbonamide, azodicarboxylate metal salts (barium azodicarboxylate, etc.), and azobisisobutyronitrile; nitroso compounds such as N,N′-dinitrosopentamethylenetetramine; hydrazine derivatives such as hydrazodicarbonamide, 4,4′-oxybis(benzenesulfonylhydrazide), and toluene sulfonylhydrazide; and amino urea compounds such as toluene sulfonylurea.

Examples of the inorganic foaming agent include ammonium carbonate, sodium carbonate, ammonium bicarbonate, sodium bicarbonate, ammonium nitrite, sodium borohydride, anhydrous monosodium citrate, and the like.

Among them, azo compounds and nitroso compounds are preferred, azodicarbonamide, azobisisobutyronitrile, and N,N′-dinitrosopentamethylenetetramine are more preferred, and azodicarbonamide is even more preferred, from the viewpoint of obtaining fine pores as well as economic benefits and safety. The thermal-decomposition foaming agents may be used alone or as a combination of two or more.

The thermal-decomposition foaming agent is preferably added in amount of 1-15 parts by mass relative to 100 parts by mass of the base resin.

The temperature for foaming under heating varies according to the decomposition temperature of the thermal-decomposition foaming agent. When an azo-based foaming agent is used, the temperature is usually 140-300° C., preferably 160-270° C.

In addition, a foaming aid may also be added to adjust the decomposition temperature and decomposition speed of the foaming agent. The foaming aids working with an azo-based foaming agent include urea-based, phosphate-based, organic acid-based, and metal salt-based foaming aids, preferably metal salt-based foaming aids, further preferably zinc oxide, stearic acid, and metal zinc salt foaming aids such as zinc stearate.

### Bidirectional Stretching

Stretching may be performed after foaming, or during foaming. It should be noted that if the resin sheet is stretched after foaming, it is preferable that the foamed resin sheet is not cooled but continuously stretched while maintaining the molten state during foaming. However, the resin sheet may also be stretched after the resin sheet is cooled, and then heated again to a molten or softened state.

The stretching ratio in the MD direction of the polymeric porous sheet is preferably 1.1-3.2 times, more preferably 1.3-3.0 times. If the stretching ratio in the MD direction of the polymeric porous sheet is greater than the lower limit, the thermal insulating property, softness, and tensile strength of the polymeric porous sheet tend to be good. On the other hand, if the stretching ratio in the MD direction of the polymeric porous sheet is smaller than the above upper limit, breaking of the polymeric porous sheet during stretching, or escaping of the foaming gas from the foaming polymeric porous sheet to reduce the foaming ratio, can be prevented, the softness and tensile strength of the polymeric porous sheet are good, and the quality tends to be uniform. In addition, the polymeric porous sheet is preferably further stretched in the TD direction at a stretching ratio within the above range.

### Calendering

In the step of calendering, the stretched resin sheet is compacted and flattened by a calender. The calendering pressure is set to 8-15 MPa and the calendering speed is set to 5-10 m/min to ensure smoothness and uniformity of the sheet. The surface temperature of the calendering roll during calendering is maintained between 80° C. and 120° C. to be compatible with the physical properties of the sheet. Finally, a polymeric porous sheet with a thickness H of 50 μm to 2,000 μm was obtained.

### Piezoelectret Sheet

The present disclosure further discloses a piezoelectret sheet, i.e. the flexible porous film layer 3 according to the present disclosure applied in the multilayer piezoelectret film element, which comprises the polymeric porous sheet according to the present disclosure. The piezoelectret sheet is formed by subjecting the polymeric porous sheet to electric polarization and surface metallization treatment.

### Electric Polarization

The polymeric porous sheet according to the present disclosure is charged by a negative corona discharge method at atmospheric pressure, in which the negative voltage Vₚ applied to the upper electrode is −16 kV to −8 kV, the distance d between the corona needle and the surface of the polymeric porous sheet is 2 cm to 4 cm, and the charging duration tₚ is 10-30 s. The corona voltage should be controlled to avoid spark discharge of air between the needle and the film. After the sample charged by corona is polarized and placed at room temperature and atmospheric pressure for a period of time until the charge distribution becomes stable, subsequent surface metallization treatment may be performed to carry out vapor deposition of electrodes on both sides.

Alternatively, a contact method (PNC 20000-3 ump, Heinzinger Company, Germany) may be used to charge the polymeric porous sheet. The polymeric porous sheet to be charged by the contact method is subjected to surface metallization treatment before charging, to carry out vapor deposition of electrodes on both sides. In the contact method, the charging voltage is 4-8 kV, the charging duration is 2-20 s, and the charging temperature is 20-120° C.

### Surface Metallization

As described above, the polymeric porous sheet is subjected to surface metallization treatment before or after the electric polarization. This step is critical to formation of effective electrodes and improvement of electrical conductivity. The surface metallization may be achieved by techniques such as physical vapor deposition (PVD), chemical vapor deposition (CVD), or electroplating. In the process of PVD, a metal or alloy is evaporated and deposited on each of the two surfaces of the polymeric porous sheet in vacuum, to form a uniform and dense metal film. In the process of CVD, a metal precursor is decomposed or reduced at a controlled temperature and pressure to form a metal film deposited on the polymeric porous sheet.

### Applications

The piezoelectret sheet made from the polymeric porous sheet according to the present disclosure may be used in flexible piezoelectric sensors, audio transducers, micro-energy harvesters, and other fields. In addition to the use in a multilayer piezoelectret film element, the polymeric porous sheet according to the present disclosure may also be applied to a protective buffer plate of a vehicle-mounted device or a display, thanks to its thermal resistance and buffering ability as well as its performance in protecting antenna components from clutter interference.

### Measurement Methods

The measurement methods involved in the present disclosure are as follows.

### Density

The density (apparent density) of the polymeric porous sheet is measured according to the method described in GB/T 40872-2021.

The Pore Diameter D_{zd} in the Thickness Direction and the Average Value Hₚ of the Cumulative Thicknesses of the Polymer Matrix

Samples are taken at random positions on the polymeric porous sheet, and cross-sectional pore images of the polymeric porous sheet are taken using SEM. The cumulative thickness Hₚₙ of the polymer matrix at a certain point of the polymeric porous sheet in parallel to the thickness direction from the upper surface to the lower surface and the pore diameter of the polymeric porous sheet are measured by SEM pore measurement software. The average value Hₚ of the cumulative thicknesses of the polymer matrix is calculated from the Hₚₙs, and the number of pores with different pore diameters is counted. D_{zd} is defined as the maximum pore diameter of a single pore in the thickness direction.

### Open Porosity

The open porosity of the polymeric porous sheet is measured according to the method described in GB/T 10799-2008 “Determination of volume percentages of open pores and closed pores in rigid foam plastics”.

### Crosslinking Degree

a. A 100 mg sample is taken from the polymer porous sheet (or base resin), and the weight A (mg) of the sample is precisely measured.
b. The sample is wrapped in a 200-mesh metal mesh, and the wrapped sample is immersed in xylene at 120° C. and left to stand for 24 hours. Through the filtering action of the metal mesh, insoluble substances can be collected inside the metal mesh. After vacuum drying, the weight B (mg) of the insoluble substances is precisely weighed.
c. The crosslinking degree (mass %) is calculated.

$$Crosslinking degree ( mass \% ) = 100 \% \times ( B / A ) .$$

### The Ratio of the Peak Area of a Melting Temperature Above 130° C. In the DSC Curve of the Xylene-Soluble Portion

After the crosslinking degree measurement is completed, the xylene includes a xylene-soluble portion of the polymeric porous sheet. 500 ml of the xylene after the crosslinking degree measurement is taken, supplemented with 300 ml pure water, shaken for 3 min, subjected to ultrasonication for 2 min, and left to stand for 6 h. Subsequently, the precipitate on the surface is collected and dried to obtain the xylene-soluble portion.

The xylene-soluble portion is tested by DSC, in which the sample is scanned with Mettler Toledo DSC3 instrument at a temperature in the range of −70 to 250° C.

The test conditions are: sample weight of 0.8-1.2 mg, in a nitrogen atmosphere, and a cycle process of:
a heating stage: from 30° C. to 180° C., at a heating rate of 10° C./min and a nitrogen flow rate of 50 ml/min, to eliminate the heat history;
a thermostatic stage: keeping at 180° C. for 2 min at a nitrogen flow rate of 50 ml/min, for buffering;
a cooling stage: from 180° C. to 30° C., at a cooling rate of 10° C./min and a nitrogen flow rate of 50 ml/min, for cooling and crystallization;
a thermostatic stage: keeping at 30° C. for 2 min, at a nitrogen flow rate of 50 ml/min, for buffering;
a heating stage: from 30° C. to 180° C., at a heating rate of 10° C./min and a nitrogen flow rate of 50 ml/min, to obtain a DSC curve.

The ratio of the peak area of a melting temperature above 130° C. to the total peak area of the xylene-soluble portion is obtained from the DCS curve.

### Dimensional Change Rate at 60° C.

It is measured according to the method described in GB/T 8811-2008. The test temperature is 60±5° C., and the duration is 20±1 h. The planar size of the sample is (150±5) mm×(150±5) mm, the surfaces are flat and parallel to each other, and the thickness is the original thickness of the sample. The dimensional changes in the length, width, and thickness are measured and averaged to obtain the dimensional change rate.

### Elongation at Break

It is measured according to the method described in GB/T 6344-2008. The stretching speed of the testing machine is 500±50 mm/min. A single-sheet sample of the polymeric porous sheet is tested.

### Stress at 10% Compression

It is measured according to the method described in GB/T18942.1-2003. The sample thickness should be at least 10 mm, and for relatively thin materials, the samples should be stacked to a thickness of at least 10 mm. Before the test starts, a pre-load of 100±10 Pa is applied to the sample. After the pre-load is completed, the compression output value of the compression measurement system is reset to zero. During the test, the sample is compressed at a rate of (50±10) % of the initial thickness per minute. The compressive stress at the first 10% compression of the sample is measured.

### Dielectric Strength

The breakdown voltage of the sample in the thickness direction is measured according to the method described in GB/T 1695-2005, wherein the measurement temperature is 23±2° C., a square plate electrode with a side length of 50±1 mm is provided, the applied voltage frequency is 50 Hz, and the voltage increasing rate is 500 V/s. The voltage at which electric breakdown occurs in the sample is called the breakdown voltage. The dielectric strength (i.e., breakdown voltage strength) of the sample is the ratio of the breakdown voltage to the thickness of the sample.

### Dielectric Constant of the Base Resin

It is measured according to the method described in GB/T 1409-2006. The measured relative permittivity is the dielectric constant.

### Melting Peak Temperature of the Base Resin

The sample is scanned with Mettler Toledo DSC3 instrument at a temperature in the range of −70 to 250° C.

The test conditions are: sample weight of 0.8-1.2 mg, in a nitrogen atmosphere, and a cycle process of:
a heating stage: from 30° C. to 180° C., at a heating rate of 10° C./min and a nitrogen flow rate of 50 ml/min, to eliminate the heat history;
a thermostatic stage: keeping at 180° C. for 2 min at a nitrogen flow rate of 50 ml/min, for buffering;
a cooling stage: from 180° C. to 30° C., at a cooling rate of 10° C./min and a nitrogen flow rate of 50 ml/min, for cooling and crystallization;
a thermostatic stage: keeping at 30° C. for 2 min, at a nitrogen flow rate of 50 ml/min, for buffering;
a heating stage: from 30° C. to 180° C., at a heating rate of 10° C./min and a nitrogen flow rate of 50 ml/min, to obtain a DSC curve.

The melting peak temperature is defined as the temperature corresponding to the vertex of the melting peak in the DSC curve. When there are multiple melting peaks, the temperature corresponding to the vertex of the melting peak having the largest area is regarded as the melting peak temperature.

### D33 Piezoelectric Constant

The piezoelectric d33 coefficient of a charged sample of the polymeric porous sheet after electric polarization is measured by a static method.

### 1. Experimental Preparation:

A sheet sample with a clean and intact surface is prepared. A ZJ-3AN quasi-static d33 measuring apparatus or another high-precision piezoelectric coefficient tester is used. It should be ensured that the apparatus has been calibrated and meets the test requirements, including a resolution of at least 0.01 pC/N.

### 2. Sample Installation:

The sheet sample is properly installed in the jig of the tester to ensure that the force applied to the sample is in the same direction as the polarization direction of the sheet, because the d33 coefficient is the piezoelectric response measured along the polarization direction.

### 3. Short Circuit and Grounding:

Before the force is applied, according to the experimental requirements, it is necessary to turn the switch to short the sample, so as to eliminate the transient charge generated during pressurization and reduce the measurement error.

### 4. Application of Force and Measurement:

Following the experimental protocol, predetermined force is slowly and uniformly applied to the sample while the amount of charge generated is monitored and recorded. The application of force should be controlled at a quasi-static condition to avoid dynamic effects caused by rapid changes which interfere with the measurement results.

### 5. Data Collection and Analysis:

With the measured amount of charge and the applied force, the d33 coefficient is calculated using the equation d33=Q/F, wherein Q is the amount of charge generated and F is the applied force.

Several examples related to the present disclosure are described below, but the present disclosure is not intended to be limited thereto.

### Example 1

20 parts by weight of linear low density polyethylene (LLDPE, trade name: Hanwha CLBA-8250B K), 20 parts by weight of polyolefin plastomer (POP, trade name: AFFINITY™ PL 1850G), 60 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending LLDPE, POP and PP in accordance with the above parts by weight and temperature) has a melting peak temperature of 145.1° C., a dielectric constant of 2.31, and a standard crosslinking degree of 61% at a radiation dose of 25 Mrad.

The extruded resin sheet was irradiated on both sides with an electron ray at an irradiation energy of 1.5 Mev and an irradiation dose of 15.3 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step was performed to obtain a polymeric porous sheet with a thickness of 300 μm, wherein the calendering pressure was 12 MPa, and the calendering speed was set to 8 m/min. The cross-section of the polymeric porous sheet (the cross-section in the thickness direction of the sheet) was scanned by SEM to observe the distribution of pores, as shown in FIG. 3.

### Example 2

30 parts by weight of linear low density polyethylene (LLDPE, trade name: Hanwha CLBA-8250B K), 30 parts by weight of polyolefin plastomer (POP, trade name: AFFINITY™ PL 1850G), 40 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending LLDPE, POP and PP in accordance with the above parts by weight and temperature) has a melting peak temperature of 135.2° C., a dielectric constant of 2.23, and a standard crosslinking degree of 79% at a radiation dose of 25 Mrad.

The extruded resin sheet was irradiated on both sides with an electron ray at an irradiation energy of 1.5 Mev and an irradiation dose of 13.2 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 350 μm.

### Example 3

20 parts by weight of linear low density polyethylene (LLDPE, trade name: Hanwha CLBA-8250B K), 80 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending LLDPE and PP in accordance with the above parts by weight and temperature) has a melting peak temperature of 149.5° C., a dielectric constant of 2.23, and a standard crosslinking degree of 40% at a radiation dose of 25 Mrad.

The extruded resin sheet was irradiated on both sides with an electron ray at an irradiation energy of 1.5 Mev and an irradiation dose of 15.3 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 1,500 μm.

### Example 4

20 parts by weight of linear low density polyethylene (LLDPE, trade name: Hanwha CLBA-8250B K), 20 parts by weight of polyolefin plastomer (POP, trade name: AFFINITY™PL 1850G), 60 parts by weight of crosslinkable polypropylene (PP, trade name: HC300B), 15 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending LLDPE, POP and PP in accordance with the above parts by weight and temperature) has a melting peak temperature of 145.1° C., a dielectric constant of 2.31, and a standard crosslinking degree of 61% at a radiation dose of 25 Mrad.

The extruded resin sheet was irradiated on both sides with an electron ray at an irradiation energy of 1.5 Mev and an irradiation dose of 14.7 Mrad to crosslink the resin sheet.

The crosslinked resin sheet was then fed into a heating furnace and foamed at 240° C., then the temperature was lowered to 120° C., and bidirectional stretching was performed at 1.35 times in the TD direction and 1.35 times in the MD direction.

Subsequently, a calendering step with a controlled calendering pressure and calendering speed was performed to obtain a polymeric porous sheet with a thickness of 530 μm.

### Example 5

30 parts by weight of linear low density polyethylene (LLDPE, trade name: Hanwha CLBA-8250B K), 70 parts by weight of crosslinkable polypropylene (PP, trade name: HC300B), 5 parts by weight of a foam masterbatch containing 95 wt % of azobisisobutyronitrile and 5 wt % of zinc oxide, 0.8 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending LLDPE and PP in accordance with the above parts by weight and temperature) has a melting peak temperature of 147.7° C., a dielectric constant of 2.23, and a standard crosslinking degree of 45% at a radiation dose of 25 Mrad.

The extruded resin sheet was irradiated on both sides with an electron ray at an irradiation energy of 2.5 Mev and an irradiation dose of 25 Mrad to crosslink the resin sheet.

The crosslinked resin sheet was then fed into a heating furnace and foamed at 240° C., then the temperature was lowered to 120° C., and bidirectional stretching was performed at 3.0 times in the TD direction and 2.8 times in the MD direction.

Subsequently, a calendering step with a controlled calendering pressure and calendering speed was performed to obtain a polymeric porous sheet with a thickness of 510 μm.

### Example 6

40 parts by weight of polyolefin plastomer (POP, trade name: AFFINITY™ PL 1850G), 60 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending POP and PP in accordance with the above parts by weight and temperature) has a melting peak temperature of 145.1° C., a dielectric constant of 2.31, and a standard crosslinking degree of 61% at a radiation dose of 25 Mrad.

The extruded resin sheet was irradiated on both sides with an electron ray at an irradiation energy of 1.5 Mev and an irradiation dose of 25.2 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 50 μm.

### Example 7

20 parts by weight of linear low density polyethylene (LLDPE, trade name: Hanwha CLBA-8250B K), 20 parts by weight of polyolefin plastomer (POP, trade name: AFFINITY™ PL 1850G), 60 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this example (i.e., the blended resin obtained by melt blending LLDPE, POP and PP in accordance with the above parts by weight and temperature) has a melting peak temperature of 145.1° C., a dielectric constant of 2.31, and a standard crosslinking degree of 61% at a radiation dose of 25 Mrad.

The extruded resin sheet was irradiated on both sides with an electron ray at an irradiation energy of 1.5 Mev and an irradiation dose of 12.5 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 1,950 μm.

### Comparative Example 1

5 parts by weight of linear low density polyethylene (LLDPE, trade name: Hanwha CLBA-8250B K), 5 parts by weight of polyolefin plastomer (POP, trade name: AFFINITY™ PL 1850G), 90 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this comparative example (i.e., the blended resin obtained by melt blending LLDPE, POP and PP in accordance with the above parts by weight and temperature) has a melting peak temperature of 153.5° C., a dielectric constant of 2.17, and a standard crosslinking degree of 27% at a radiation dose of 25 Mrad.

The extruded resin sheet was irradiated on both sides with an electron ray at an irradiation energy of 1.5 Mev and an irradiation dose of 15.3 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 230 μm.

### Comparative Example 2

40 parts by weight of linear low density polyethylene (LLDPE, trade name: Hanwha CLBA-8250B K), 40 parts by weight of polyolefin plastomer (POP, trade name: AFFINITY™ PL 1850G), 20 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this comparative example (i.e., the blended resin obtained by melt blending LLDPE, POP and PP in accordance with the above parts by weight and temperature) has a melting peak temperature of 132.3° C., a dielectric constant of 2.39, and a standard crosslinking degree of 88% at a radiation dose of 25 Mrad.

The extruded resin sheet was irradiated on both sides with an electron ray at an irradiation energy of 1.5 Mev and an irradiation dose of 12.5 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 2,500 μm.

### Comparative Example 3

20 parts by weight of linear low density polyethylene (LLDPE, trade name: Hanwha CLBA-8250B K), 20 parts by weight of polyolefin plastomer (POP, trade name: AFFINITY™ PL 1850G), 60 parts by weight of crosslinkable polypropylene (PP, trade name: HC300B), 20 parts by weight of a foam masterbatch containing 95 wt % of azobisisobutyronitrile and 5 wt % of zinc oxide, 0.1 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this comparative example (i.e., the blended resin obtained by melt blending LLDPE, POP and PP in accordance with the above parts by weight and temperature) has a melting peak temperature of 145.1° C., a dielectric constant of 2.31, and a standard crosslinking degree of 61% at a radiation dose of 25 Mrad.

The extruded resin sheet was irradiated on both sides with an electron ray at an irradiation energy of 0.5 Mev and an irradiation dose of 12.5 Mrad to crosslink the resin sheet.

The crosslinked resin sheet was then fed into a heating furnace and foamed at 300° C., then the temperature was lowered to 120° C., and bidirectional stretching was performed at 1.1 times in the TD direction and 1.1 times in the MD direction.

Subsequently, a calendering step with a controlled calendering pressure and calendering speed was performed to obtain a polymeric porous sheet with a thickness of 300 μm.

### Comparative Example 4

20 parts by weight of linear low density polyethylene (LLDPE, trade name: Hanwha CLBA-8250B K), 20 parts by weight of polyolefin plastomer (POP, trade name: AFFINITY™ PL 1850G), 60 parts by weight of crosslinkable polypropylene (PP, trade name: HC300B), 3 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this comparative example (i.e., the blended resin obtained by melt blending LLDPE, POP and PP in accordance with the above parts by weight and temperature) has a melting peak temperature of 145.1° C., a dielectric constant of 2.31, and a standard crosslinking degree of 61% at a radiation dose of 25 Mrad.

The extruded resin sheet was irradiated on both sides with an electron ray at an irradiation energy of 2.5 Mev and an irradiation dose of 25.5 Mrad to crosslink the resin sheet.

The crosslinked resin sheet was then fed into a heating furnace and foamed at 160° C., then the temperature was lowered to 120° C., and bidirectional stretching was performed at 3.5 times in the TD direction and 3.5 times in the MD direction.

Subsequently, a calendering step with a controlled calendering pressure and calendering speed was performed to obtain a polymeric porous sheet with a thickness of 300 μm.

### Comparative Example 5

15 parts by weight of linear low density polyethylene (LLDPE, trade name: Hanwha CLBA-8250B K), 85 parts by weight of crosslinkable polypropylene (PP, trade name: HC300B), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this comparative example (i.e., the blended resin obtained by melt blending LLDPE and PP in accordance with the above parts by weight and temperature) has a melting peak temperature of 152.4° C., a dielectric constant of 2.28, and a standard crosslinking degree of 32% at a radiation dose of 25 Mrad.

The extruded resin sheet was irradiated on both sides with an electron ray at an irradiation energy of 1.5 Mev and an irradiation dose of 15.3 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 200 μm.

### Comparative Example 6

20 parts by weight of linear low density polyethylene (LLDPE, trade name: Hanwha CLBA-8250B K), 20 parts by weight of polyolefin plastomer (POP, trade name: AFFINITY™ PL 1850G), 60 parts by weight of crosslinkable low density polyethylene (LDPE, trade name: SINOPEC LD607), 10 parts by weight of a foam masterbatch containing 95 wt % of azobisisobutyronitrile and 5 wt % of zinc oxide, 0.5 parts by weight of trimethylolpropane trimethacrylate (crosslinking aid, trade name: Light Ester TMP, manufactured by KYOEISHACHEMICAL CO., LTD., non-volatile component: 100 mass %), 0.5 parts by weight of an antioxidant (phenolic antioxidant Irganox 1010), 0.1 parts by weight of an ultraviolet light absorber (Tinuvin 326), and 0.5 parts by weight of a processing aid (a mixture formed by mixing paraffin oil and erucylamide in a mass ratio of 1:1) were mixed in a high-speed mixer, kneaded at 135° C., and then extruded into a strip sheet to obtain a raw material mixture. The base resin of this comparative example (i.e., the blended resin obtained by melt blending LLDPE, POP and LDPE in accordance with the above parts by weight and temperature) has a melting peak temperature of 123.1° C., a dielectric constant of 2.43, and a standard crosslinking degree of 76% at a radiation dose of 25 Mrad.

The extruded resin sheet was irradiated on both sides with an electron ray at an irradiation energy of 1.5 Mev and an irradiation dose of 15.3 Mrad to crosslink the resin sheet.

The crosslinked resin sheet was then fed into a heating furnace and foamed at 200° C., then the temperature was lowered to 120° C., and bidirectional stretching was performed at 1.5 times in the TD direction and 1.8 times in the MD direction.

Subsequently, a calendering step with a controlled calendering pressure and calendering speed was performed to obtain a polymeric porous sheet with a thickness of 230 μm.

The polymeric porous sheets of Examples 1-7 and Comparative Examples 1-6 were measured for the density, the average pore diameter D_{zd}, the ratio of pores having a D_{zd} in the range of 5 μm to 50 μm, Hₚ/H, the open porosity, the crosslinking degree, the ratio of the peak area of a melting temperature above 130° C. in the DSC curve of the xylene-soluble portion, the dimensional change rate at 60° C., the elongation at break, the compressive stress at 10% compression, and the dielectric strength.

The polymeric porous sheets of Examples 1-7 and Comparative Examples 1-6 were placed in an electric field of −8 kV/mm for 20 s at room temperature, and the distance d between the corona needle and the surface of the polymeric porous sheet was set to 4 cm. Each of the electrically polarized polymeric porous sheets of Examples 1-7 and Comparative Examples 1-6 was measured for the D33 piezoelectric constant.

The characteristics of Examples 1-7 and Comparative Examples 1-6 are shown in Table 1 below:

TABLE 1

| | Structural characterization | | | | | | |
|---|---|---|---|---|---|---|---|
| | | | Average | Ratio of | | Ratio of | |
| | | | pore | D_{zd} in the | | the peak | |
| | | | diameter | range of 5 | Crosslinking | area above | Open |
| | Density | Hp/H | D_{zd} | μm to 50 μm | degree | 130° C. | Porosity |
| Unit | kg/m³ | % | μm | % | % | % | % |
| Example 1 | 350 | 25.9 | 43 | 95 | 40 | 25 | 5 |
| Example 2 | 425 | 17.6 | 52 | 92 | 34 | 13 | 2 |
| Example 3 | 520 | 20.3 | 32 | 98 | 13 | 38 | 3 |
| Example 4 | 330 | 30 | 75 | 82 | 35 | 27 | 15 |
| Example 5 | 490 | 27.5 | 15 | 82 | 37 | 21 | 4 |
| Example 6 | 900 | 57 | 12 | 100 | 68 | 26 | 3 |
| Example 7 | 100 | 8 | 76 | 81 | 15 | 23 | 18 |
| Com. Ex. 1 | 440 | 26.3 | 9 | 66 | 12 | 40 | 17 |
| Com. Ex. 2 | 97 | 29.2 | 45 | 97 | 25 | 9 | 21 |
| Com. Ex. 3 | 53 | 4.9 | 156 | 43 | 19 | 23 | 20 |
| Com. Ex. 4 | 350 | 69 | 5 | 77 | 76 | 25 | 11 |
| Com. Ex. 5 | 730 | 17.3 | 35 | 63 | 8 | 67 | 18 |
| Com. Ex. 6 | 490 | 19.4 | 47 | 91 | 43 | 0 | 16 |

Physical and chemical properties of Examples 1-7 and Comparative Examples 1-6 are shown in Table 2 below:

TABLE 2

| | Properties | | | | |
|---|---|---|---|---|---|
| | Dimensional | | | | |
| | change rate | Elongation | Compressive | Dielectric | Piezoelectric |
| | at 60° C. | at break | stress at 10% | strength | constant |
| | Unit | | | | |
| | % | % | KPa | MV/m | pC/N |
| Example 1 | 2 | 150 | 25 | 32 | 450 |
| Example 2 | 4.7 | 125 | 13 | 23 | 75 |
| Example 3 | 0.8 | 197 | 125 | 55 | 150 |
| Example 4 | 1.3 | 200 | 34 | 35 | 103 |
| Example 5 | 2.4 | 230 | 97 | 17 | 669 |
| Example 6 | 4.9 | 250 | 145 | 55 | 73 |
| Example 7 | 4.5 | 105 | 5.7 | 11 | 53 |
| Com. Ex. 1 | 1.5 | 350 | 265 | 43 | 45 |
| Com. Ex. 2 | 13.1 | 93 | 5.3 | 13 | 41 |
| Com. Ex. 3 | 6.7 | 130 | 3.2 | 9 | 62 |
| Com. Ex. 4 | 2.4 | 129 | 190 | 49 | 0 (corona |
| | | | | | breakdown) |
| Com. Ex. 5 | 1.0 | 310 | 350 | 27 | 45 |
| Com. Ex. 6 | 27 | 103 | 125 | 13 | 23 |

It can be seen that, in Comparative Example 1, due to the small average pore diameter D_{zd}, the number ratio of the pores having a D_{zd} in the range of 5 μm-50 μm is low, and the compressive stress at 10% is too large, indicating poor flexibility; meanwhile, the pores in the polymeric porous sheet are small, the continuity of the polymer matrix in the porous sheet is increased, and the deformation of the polymer chains and the reorientation of the polar groups are critical to generation of charge. In view of the fact that the piezoelectric constant of Comparative Example 1 is smaller than that of the Examples, it can be seen that if the pores are too dense, the movement of the polymer chains may be limited, thereby reducing the amount of charge generated under mechanical stress, resulting in a decrease in the piezoelectric constant of the material. Comparative Example 2 have thickness and density not within the scope of the present invention, and is not ideal in terms of the piezoelectric constant, the elongation at break, and the dimensional change rate at 60° C. In Comparative Example 3, due to the large average pore diameter D_{zd}, the number ratio of the pores having a D_{zd} in the range of 5 μm to 50 μm is low, and the ratio of the polymer matrix in the thickness direction is too low, indicating that the dielectric strength of the polymer matrix is insufficient, the dimensional change rate at 60° C. is too large, and the compressive stress at 10% is too small. In Comparative Example 4, the ratio of the polymer matrix in the thickness direction is too high, making it difficult to polarize, and corona breakdown occurs after the polarization voltage is increased. In Comparative Example 5, the melting peak of the base resin is too high and crosslinking is not easy to occur, and as a result, a bimodal distribution of large and small pores is seen in the thickness direction, resulting in a low number ratio of pores having a D_{zd} in the range of 5 μm-50 μm, and the resultant piezoelectric constant and compressive stress at 10% are not ideal. In Comparative Example 6, LDPE was used instead of PP, the ratio of the melting peak area of a melting temperature above 130° C. in the DSC curve is 0, and thus the piezoelectric constant and the dimensional change rate at 60° C. were not ideal.

The objectives, technical solutions, and beneficial effects of the present disclosure are further described in detail in the foregoing specific embodiments. It should be understood that the foregoing descriptions are merely specific embodiments of the present disclosure, but are not intended to limit the scope of protection of the present disclosure. Any modifications, equivalents, or improvements made without departing from the spirit and principle of the present disclosure shall fall within the scope of protection of the present disclosure.

1. A multilayer piezoelectret film element, comprising a first conductive layer, a flexible porous film layer, and a second conductive layer in sequence, wherein the flexible porous film layer comprises a polymeric porous sheet, and the polymeric porous sheet has a thickness H of 50 μm to 2,000 μm and a density of 100 kg/m³ to 900 kg/m³;
the number of pores having a D_{zd} in the range of 5 μm to 50 μm account for 80% or more of the total number of pores in the polymeric porous sheet, where D_{zd} is defined as the maximum pore diameter of a single pore in the thickness direction;
Hₚ/H is 5%-60%, where Hₚ is defined as the average value of the cumulative thickness of the polymer matrix excluding pores in the thickness direction, and H is defined as the thickness of the polymeric porous sheet; and
the dielectric strength of the polymeric porous sheet in the thickness direction is 10 to 60 MV/m.

2. The multilayer piezoelectret film element according to claim 1, wherein the other side of the first conductive layer opposite to the flexible porous film layer is further provided with a base support layer, and the other side of the second conductive layer opposite to the flexible porous film layer is further provided with an overcoat layer.

3. The multilayer piezoelectret film element according to claim 1, wherein the pores in the polymeric porous sheet contain gas, and the gas comprises one or more selected from air, nitrogen, oxygen, argon, carbon dioxide, fluorine gas, chlorine gas, and water vapor; and/or
the flexible porous film layer is formed by subjecting the polymeric porous sheet to electric polarization and surface metallization treatment.

4. A polymeric porous sheet, wherein the polymeric porous sheet has a thickness H of 50 μm to 2,000 μm and a density of 100 kg/m³ to 900 kg/m³;
the number of pores having a D_{zd} in the range of 5 μm to 50 μm account for 80% or more of the total number of pores in the polymeric porous sheet, where D_{zd} is defined as the maximum pore diameter of a single pore in the thickness direction;
Hₚ/H is 5%-60%, where Hₚ is defined as the average value of the cumulative thickness of the polymer matrix excluding pores in the thickness direction, and H is defined as the thickness of the polymeric porous sheet; and
the dielectric strength of the polymeric porous sheet in the thickness direction is 10 to 60 MV/m.

5. The polymeric porous sheet according to claim 4, wherein the polymeric porous sheet comprises at least a polypropylene-based resin.

6. The polymeric porous sheet according to claim 4, wherein the polymeric porous sheet is made from at least a base resin, the base resin is a blended resin obtained by melt blending of a composition comprising two or more polyolefin resins but not subjected to crosslinking and foaming, and the base resin has a dielectric constant of 2.2 to 2.4 and a melting peak temperature of 135° C. to 150° C.

7. The polymeric porous sheet according to claim 6, wherein the base resin for the polymeric porous sheet has a standard crosslinking degree of 40% to 80% at a radiation dose of 25 Mrad.

8. The polymeric porous sheet according to claim 4, wherein the polymeric porous sheet is a crosslinked foamed sheet, and the polymeric porous sheet has a crosslinking degree of 10% to 70%.

9. The polymeric porous sheet according to claim 4, wherein the polymeric porous sheet comprises a xylene-soluble portion and a xylene-insoluble portion; wherein in the DSC curve of the soluble portion, the ratio of the peak area of a melting temperature above 130° C. to the total peak area is 10% to 40%.

10. The polymeric porous sheet according to claim 4, wherein the polymeric porous sheet has a dimensional change rate of −5% to 5% at 60° C.

11. The polymeric porous sheet according to claim 4, wherein the polymeric porous sheet has an elongation at break greater than 100%, and a compressive stress at 10% of 5 kPa to 150 kPa.

12. A method for manufacturing a polymeric porous sheet according to claim 4, comprising subjecting at least a base resin to extrusion molding, electron beam radiation crosslinking, foaming at atmospheric pressure and a high temperature, bidirectional stretching, and calendering, to manufacture the polymeric porous sheet;
wherein the base resin is a blended resin obtained by melt blending of a composition comprising two or more polyolefin resins but not subjected to crosslinking and foaming; the base resin has a dielectric constant of 2.2 to 2.4 and a melting peak temperature of 135° C. to 150° C.; and the base resin has a standard crosslinking degree of 40% to 80% at a radiation dose of 25 Mrad.
